(19) United States
(12) Patent Application Publication
(10) Pub. No.: US 2023/0203242 A1
(43) Pub. Date: Jun. 29, 2023

(54) A METHOD FOR MANUFACTURING AN OLIGOMERIC POLYETHYLENE TEREPHTHALATE (PET) SUBSTRATE

(71) Applicant: Koch Technology Solutions, LLC, Wichita, KS (US)

(72) Inventors: Clive Alexander HAMILTON, North Yorkshire (GB); George Malcolm WILLIAMSON, Wilmington, NC (US)

(73) Assignee: Koch Technology Solutions, LLC, Wichita, KS (US)

(21) Appl. No.: 17/927,362

(22) PCT Filed: Jun. 2, 2021
(86) PCT No.: PCT/IB2021/054841

§ 371 Date: Nov. 23, 2022

Related U.S. Application Data
(60) Provisional application No. 63/035,179, filed on Jun. 5, 2020.

(51) Int. Cl. C08G 63/183

(52) U.S. Cl. CPC C08G 63/183

(57) ABSTRACT

A method for producing an oligomeric polyethylene terephthalate (PET) substrate for use in a recycled PET (rPET) manufacturing process, comprising (i) adding recycled bis-hydroxylethylenete rephthalate (rBHET) and an under-esterified purified terephthalic acid (PTA) oligomer to a reaction zone; and ii) reacting the rBHET and the under-esterified PTA oligomer in the reaction zone to produce an oligomeric PET substrate represented by the formula (I), wherein R1 is a carboxyl end group or a hydroxyl end group, R2 is a carboxyl end group or a hydroxyl end group, and n is a degree of polymerisation (Dp).

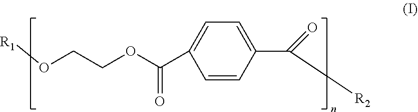

### CROSS-REFERENCE TO RELATED APPLICATIONS

This application claims the benefit of U.S. Provisional Application No. 63/035,179, filed Jun. 5, 2020, the disclosure of which is incorporated herein by reference in its entirety.

### FIELD

The present disclosure relates to methods for manufacturing an oligomeric polyethylene terephthalate (PET) substrate from recycled bis-hydroxylethyleneterephthalate (rBHET), the oligomeric PET substrate for use in manufacturing recycled PET (rPET) and also PET polymer which includes 5-100% rPET, produced from the oligomeric PET substrate.

### BACKGROUND

PET (polyethylene terephthalate) is a synthetic material that was first made in the mid-1940s. PET has desirable properties and processing abilities and hence is now used extensively on a global scale for packaging applications in the food and beverage industries and for industrial products, as well as in the textile industry.

Typically, PET has petrochemical origins. Purified terephthalic acid is first formed via aerobic catalytic oxidation of p-xylene in acetic acid medium in a purified terephthalic acid manufacturing facility. This purified terephthalic acid (PTA) is subsequently reacted with ethylene glycol to produce a PTA-based oligomer (and water), which polycondenses to form PET polymer. An alternative route to PET polymer is via polymerisation of a bis-hydroxylethyleneterephthalate (BHET) monomer, although this route is less favorable from a process economic point of view. The BHET monomer is formed through the reaction of dimethylterephthalate (DMT) (a diester formed from terephthalic acid and methanol) with ethylene glycol, and then the BHET monomer polymerises with itself to form longer chains of PET.

In a typical PET manufacturing process, there are three main stages in the melt-phase process to make the PET polymer: (1) esterification, (2) pre-polymerisation, and (3) polymerisation. When making PET resin, the PET polymer enters a further solid-state polymerisation (SSP) stage to make further changes which include increasing the molecular weight of the polymer. In the initial esterification stage, the PTA (or DMT) and ethylene glycol are mixed and fed into an esterification unit, where esterification, which may be catalysed or uncatalyzed, takes place under atmospheric pressure and a temperature in the range of 270° C. to 295° C. Water (or methanol in the case of DMT) resulting from the esterification reaction and excess ethylene glycol are vaporised. Additives, including catalysts and toners, are typically added to the process in between the esterification stage and the subsequent pre-polymerisation stage. In the pre-polymerisation stage, the product from the esterification unit is sent to the pre-polymerisation unit, and reacted with extra ethylene glycol at a temperature in the range of 270° C. to 295° C. under significantly reduced pressure to allow the degree of polymerisation of the oligomer to increase. During the polymerisation stage, the product from the pre-polymerisation stage is again subjected to low pressures and a temperature in the range of 270° C. to 295° C. in a horizontal polymerisation unit to further allow an increase in the degree of polymerisation to approximately 80-120 repeat units. In embodiments, this is referred to as the Finisher. When making PET resin, a fourth, solid-state polymerisation (SSP) stage is usually required involving a crystallisation step wherein the amorphous pellets produced in the melt phase process are converted to crystalline pellets, which are then subsequently processed further depending on the final PET product, which may be as diverse as containers/bottles for liquids and foods, or industrial products and resins.

It is desirable to recycle post-consumer PET-containing waste material to reduce the amount of plastic sent to landfill. One known recycling method is to take post-consumer PET-containing waste material to produce post-consumer recycled (PCR) flake. This PCR flake may be glycolysed to convert it to recycled bis-hydroxylethyleneterephthalate (rBHET). This rBHET can then be used in a PET manufacturing process to make recycled PET (rPET; so-called because the oligomer upon which it is based is derived from post-consumer PET or PCR, rather than PTA or DMT). This circumvents the need to use more PTA with petrochemical origins, in combination with ethylene glycol, to make a PTA-based oligomer in a virgin (vPTA) process or to make virgin (vBHET) in a virgin (vDMT) process. In addition, since lower amounts of petrochemicals are required to make recycled PET (rPET) as compared to new PET, known as virgin PET (vPET), rPET consequently has a lower carbon footprint than vPET. Therefore, rPET is attractive based on its ‘green’ credentials, which themselves may confer economic benefits in certain jurisdictions.

However, rPET made from rBHET tends to have lower reactivity in the melt phase process and in the solid phase polymerisation stage. If rBHET is used in a PET manufacturing process, the amount of rPET manufactured is approximately 20% lower than if a PTA-based oligomer is used (i.e., short-chain PET oligomers made through esterification of purified terephthalic acid with ethylene glycol). Further still, rPET made from rBHET tends to be darker (lower L*) and more yellow, which is mainly due to impurities present in the rPET polymer. At present, therefore, rPET manufacturing processes using rBHET (glycolysis product of PET waste) are neither attractive nor competitive when compared with vPET processes using a PTA-based oligomer or vBHET.

Therefore, there exists a need to produce an oligomeric PET substrate which has an increased reactivity and consequently increased ability to polymerise to form rPET in order to compete with processes making vPET.

### SUMMARY OF INVENTION

The present disclosure provides, inter alia, a method for producing an oligomeric PET substrate for use in a rPET manufacturing process, the method comprising the steps of: i) adding recycled bis-hydroxylethyleneterephthalate (rBHET) and an under-esterified purified terephthalic acid (PTA) oligomer to a reaction zone; and ii) reacting the rBHET and the under-esterified PTA oligomer in the reaction zone to produce an oligomeric PET substrate represented by Formula I:

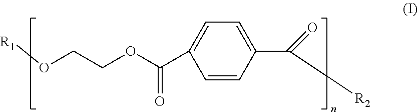

wherein R1 is a carboxyl end group or a hydroxyl end group, R2 is a carboxyl end group or a hydroxyl end group, and n is a degree of polymerisation (Dp).

In some embodiments, n is from 1 to 10, preferably 3 to 7, and more preferably n is 6. In some embodiments, the oligomeric PET substrate has a CEG of between 300 to 1500 mols acid ends/te of material, preferably from 500 to 1200 mols acid ends/te of material, and more preferably from 700 to 1100 mols acid ends/te of material. In some embodiments, the oligomeric PET substrate has a hydroxyl end group: carboxyl end group ratio in the range of 1.66 to 6.66, preferably in a range of 2.22 to 4.0. In some embodiments, the under-esterified PTA oligomer is in the range 5 wt % and 50 wt %, preferably in a range of 20 wt % to 40 wt %.

In some embodiments, the rBHET is reacted with the under-esterified PTA oligomer at a temperature between 120° C. to 300° C., preferably from 150° C. to 270° C. In some embodiments, the reaction zone comprises a residence time of between 30 minutes to 120 minutes, preferably from 40 minutes to 50 minutes. In some embodiments, the rBHET is reacted with the under-esterified PTA oligomer at a pressure between 3 barg to 20 barg. In some embodiments, the rBHET is fed into an esterifier in addition to PTA and ethylene glycol. In some embodiments, rBHET is fed into said esterifier at a ratio in a range of 40 wt %-55 wt %, preferably in a range of 45 wt % to 51 wt %.

In some embodiments, the rBHET is reacted with the under-esterified PTA oligomer using an exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst, a tin-containing catalyst and combinations thereof. In some embodiments, the catalyst comprises at least one of antimony trioxide, antimony glycolate, antimony triacetate, titanium alkoxide, zinc acetate or manganese acetate. In some embodiments, the oligomeric PET substrate is fed directly or indirectly into said rPET manufacturing process.

The present disclosure also provides an oligomeric PET substrate represented by Formula I

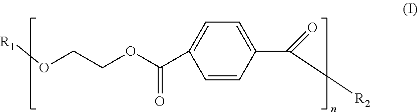

wherein R1 is a carboxyl end group or a hydroxyl end group, R2 is a carboxyl end group or a hydroxyl end group, and n is a degree of polymerisation, and wherein said oligomeric PET substrate comprises at least two of the following characteristics: i) n is a degree of polymerisation of 1-10; ii) a CEG (mols acid ends/metric ton (te) of material) of from 300 to 1500; and iii) hydroxyl end group: carboxyl end group ratio in the range of 1.66 to 66.6. In some embodiments, the oligomeric PET substrate is used in synthesis of a polymer including 5-100% rPET.

The present disclosure also provides a provides a PET polymer made from 5-100% rPET, produced from the oligomeric PET substrate as represented by Formula I.

### BRIEF DESCRIPTION OF THE FIGURES

FIG. 1A is a schematic showing a system in accordance with one aspect of the disclosure where rBHET and under-esterified PTA oligomer are reacted to produce an oligomeric PET substrate.

FIG. 1B shows a schematic of an alternative aspect of the disclosure where BHET, ethylene glycol and PTA are reacted to produce the oligomeric PET substrate.

FIG. 2 is a graph illustrating finisher pressure as a function of the oligomer OH:COOH ratio in accordance with the simulated process for producing the PET described in Example 1.

FIG. 3 is a graph illustrating plant rate as a function of the oligomer OH:COOH ratio in accordance with the simulated process for producing the PET described in Example 1.

FIG. 4 is a graph illustrating finisher pressure as a function of an COOH esterifier ratio in accordance with the simulated process of producing the PET described in Example 3.

FIG. 5 is a graph illustrating finisher pressure against the oligomer OH:COOH in accordance with the simulated process at 50% BHET feed for producing the PET described in Example 3.

FIG. 6 is a graph illustrating finisher pressure as a function of an COOH esterifier ratio in accordance with the simulated process at 30% BHET feed for producing the PET described in Example 3.

FIG. 7 is a graph illustrating finisher pressure against the oligomer OH:COOH in accordance with the simulated process at 30% BHET feed for producing the PET described in Example 3.

FIG. 8 is a graph illustrating finisher pressure against an esterifier residence time in accordance with the simulated process at 50% BHET feed for producing the PET described in Example 3.

FIG. 9 is a graph illustrating finisher pressure against the oligomer OH:COOH in accordance with the simulated process at 50% BHET feed for producing the PET described in Example 3.

### DETAILED DESCRIPTION

Disclosed herein are methods to produce an oligomeric PET substrate from rBHET, an oligomeric PET substrate for use in manufacturing rPET, and PET polymer which is made from the oligomeric PET substrate. In the methods of the present disclosure, rBHET and an under-esterified PTA oligomer are added to a reaction zone and reacted in the reaction zone under conditions effective to produce the oligomeric PET substrate. A determination of the degree of esterification (De) is made by calculating the percentage molar conversion of terephthalic acid so for example: 90% conversion of 100 g of terephthalic acid would release ((100*0.9)/166)*2*18=19.52 g of water.

The methods disclosed herein address a problem recognized in the art with respect to the lower reactivity of rBHET as compared to vBHET in the manufacturing of PET oligomers and the consequentially lower yields of PET oligomers prepared from rBHET as compared to PET oligomers prepared from vBHET or PTA. In particular, the disclosure provides a means to improve the efficiency of rPET manufacturing by reacting BHET with an under-esterified PTA oligomer during the manufacturing process. These methods increase the ability of practitioners to prepare PET from recycled starting materials in a manner that is economically competitive with methods for preparing virgin PET.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. In case of conflict, the present specification, including definitions, will control.

In addition, the materials, methods, and examples are illustrative only and not intended to be limiting. The details of one or more embodiments of the invention are set forth in the accompanying drawings and the description below. Other features, objects, and advantages of the invention will be apparent from the description and the drawings, and from the claims. The word “comprising” in the claims may be replaced by “consisting essentially of” or with “consisting of,” according to standard practice in patent law.

Unless specifically stated otherwise or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The term “PET” or “PET polymer” refers to polyethylene terephthalate.

The term “PTA” refers to purified terephthalic acid.

The term “vPTA” refers to PTA synthesised via aerobic catalytic oxidation of p-xylene in acetic acid medium

As used herein, “PTA-based oligomer” refers to a short-chain PET oligomer synthesised through a process requiring esterification of purified terephthalic acid with ethylene glycol. Purified terephthalic acid (PTA) is reacted with ethylene glycol to produce the PTA-based oligomer (and water), which polycondenses to form PET polymer. When PTA is reacted with ethylene glycol, a short chain PTA-based oligomer is formed which is characterised by a Dp (degree of polymerisation or number of repeat units) and a CEG (or carboxyl acid end group concentration). The degree of polymerisation (Dp) is calculated from the number average molecular weight Mn by the following formula: Dp=(Mn−62)/192, in which Mn is calculated by rearranging the following correlation to IV (intrinsic viscosity): IV=1.7e-4 (Mn)^{0.83}. The intrinsic viscosity (IV) of the polyester can be measured by a melt viscosity technique equivalent to ASTM D4603-96. Typically, for a PTA-based oligomer formed by reacting PTA with ethylene glycol, the degree of polymerisation is usually between 3 and 7 and the CEG is usually between 500 and 1200 (mols acid ends/te of material). The hydroxyl end group (HEG)/carboxyl end group (CEG) ratio is determined from the CEG measurement and the rearrangement of following calculation of Mn: Mn=2e6/(CEG+HEG).

As used herein, “PET manufacturing process” refers to a facility that produces PET. Such a facility may be integrated with a PTA manufacturing process or may be entirely independent.

As used herein, “post-consumer PET-containing waste material” refers to any waste stream that contains at least 10% PET waste. The post-consumer PET-containing waste material may therefore include 10% to 100% PET. The post-consumer PET-containing waste material may be municipal waste which itself includes at least 10% PET waste, such as PET plastic bottles or PET food packaging or any consumer recycled PET-containing waste material such as waste polyester fibre. Waste polyester fibre sources include items such as clothing items (shirts, trousers, dresses, coats, etc.), bed linen, duvet linings or towels. The “post-consumer PET-containing waste material” may further include post-consumer recycled (PCR) flake, which is waste PET plastic bottles which have been mechanically broken into small pieces in order to be used in a recycling process.

As used herein, “vPET” refers to virgin PET, which is PET synthesised through a process requiring esterification of purified terephthalic acid with ethylene glycol. The purified terephthalic acid (PTA) is reacted with ethylene glycol to produce a PTA-based oligomer (and water), which polycondenses to form PET polymer. Alternatively, vPET may be formed through the reaction of dimethylterephthalate (DMT) (a diester formed from terephthalic acid and methanol) with ethylene glycol. A BHET monomer is formed through the reaction of dimethylterephthalate (DMT) (a diester formed from terephthalic acid and methanol) with ethylene glycol, and then the BHET monomer polymerises with itself to form longer chains of PET.

As used herein, “rPET” refers to recycled PET, which is PET manufactured entirely or at least partially from oligomers that have been derived from post-consumer PET-containing waste material. The rPET may be synthesised from oligomers that are 100% derived from a post-consumer PET-containing waste material. Alternatively, the rPET may be synthesised from a combination of oligomers which include those derived from post-consumer PET-containing waste material and also those from vBHET or PTA-based oligomers used to make vPET. In one non-limiting embodiment, the rPET includes at least 5% oligomeric PET substrate derived from post-consumer PET-containing waste material. In another non-limiting embodiment, the rPET includes at least 50% oligomeric PET substrate derived from post-consumer PET-containing waste material. In yet another non-limiting embodiment, the rPET includes at least 80% oligomeric PET substrate derived from post-consumer PET-containing waste material.

As used herein, “rPET manufacturing process” refers to both manufacturing processes and facilities that have been purposely designed and built to synthesise recycled PET (rPET), namely PET from substrates that include those derived from any post-consumer PET-containing waste material in addition to virgin substrates (i.e., vBHET or PTA-based oligomer), and also manufacturing processes and facilities that were built to synthesise vPET but which have been modified or retrofitted to allow the production of rPET. Changes that are required to a vPET facility in order to produce rPET are typically not major structurally but instead require a number of process changes.

The term “BHET” refers to the bis-hydroxylethyleneterephthalate monomer (C₁₂H₁₄O), including all structural isomers, which is characterised as having no carboxyl end groups, namely a carboxyl acid end group concentration (CEG) of zero. The chemical structure of the para-isomer of the BHET monomer is represented below:

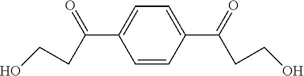 [SMILES: O=C(CCO)c1ccc(C(=O)CCO)cc1]

To produce PET, BHET reacts with itself to make longer chains in a polycondensation reaction, thereby forming polyethylene terephthalate and liberating ethylene glycol in the process. BHET, namely the BHET monomer, is typically formed through reaction of dimethylterephthalate (DMT) with ethylene glycol but it is also a minor component of the oligomer made from PTA plus ethylene glycol, i.e., part of the oligomeric molecular weight distribution. When PTA is reacted with ethylene glycol, a short chain PTA-based oligomer is formed which is characterised by a Dp (degree of polymerisation or number of repeat units) and a CEG (or carboxyl acid end group concentration). Typically, for a PTA-based oligomer formed by reacting PTA with ethylene glycol, the degree of polymerisation is usually between 3 and 7 and the CEG is usually between 500 and 1200 (mols acid ends/te of material).

The term “vBHET” refers to virgin BHET, which is the BHET monomer formed through reaction of dimethylterephthalate (DMT) with ethylene glycol.

The term “rBHET” refers to recycled BHET, which is the BHET molecule produced by glycolyzing PET. Post-consumer PET-containing waste material, such as PET plastic bottles, is mechanically broken down to produce post-consumer recycled (PCR) flake (PCR flake). This PCR flake is then glycolysed to convert it to rBHET.

As used herein, “oligomeric PET substrate” refers to a molecule according to Formula I:

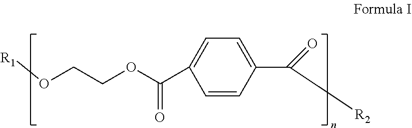

Either end of Formula I may be a carboxyl end group or a hydroxyl end group. Therefore, either R₁ or R₂ may be a carboxyl end group or a hydroxyl end group. The optimum ratio of hydroxyl end group: carboxyl end group in the oligomeric PET substrate is typically between 1.66 and 6.66. Formula I polymerises with itself in an esterification reaction, in which carboxyl end groups react with hydroxyl end groups to form an ester link, liberating water. The “n” represents the degree of polymerisation (Dp) or number of repeat units of Formula I that exist in the oligomeric PET substrate and may, for example, be between 3 and 7. In addition to being characterised by the degree of polymerisation (Dp), the oligomeric PET substrate is also characterised by its carboxyl acid end group concentration, referred to herein as CEG. The CEG (units are mols acid ends/te of material) may, for example, be between 500 and 1200.

Aspects of the present disclosure provide methods to produce an oligomeric PET substrate. Approaches to produce rPET have typically used the process of glycolyzing PET (or waste sources having PET) using for example, ethylene glycol, to produce bis-hydroxylethyleneterephthalate (rBHET). This approach to producing rPET uses rBHET and polymerises it to produce rPET. However, this rBHET has a lower reactivity as compared to a PTA-based oligomer formed through an esterification reaction of purified terephthalic acid with ethylene glycol. Therefore, when used to make rPET, the rBHET yields approximately 20% less the amount of rPET as compared to the amount of vPET made using a PTA-based oligomer (formed through an esterification reaction of purified terephthalic acid with ethylene glycol), for comparable processes.

In the present disclosure, it is unexpectedly found that rBHET can be reacted with under-esterified PTA oligomer to produce an oligomeric PET substrate having an increased reactivity as compared to unmodified rBHET. Specifically, under-esterified PTA oligomer is reacted with rBHET to produce an oligomeric PET substrate. This oligomeric PET substrate is shown to have an increased reactivity as compared to unmodified oligomer, i.e., rBHET, as shown in the Examples section. Therefore, aspects of the present disclosure relate to a method for producing an oligomeric PET substrate by reacting rBHET with under-esterified PTA oligomer.

The oligomeric PET substrate is represented by Formula I:

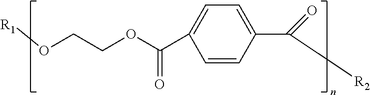

In embodiments, either end of Formula I may be a carboxyl end group or a hydroxyl end group. Therefore, either R1 or R2 may be a carboxyl end group or a hydroxyl end group. As described herein, Formula I has an optimum ratio of hydroxyl end group: carboxyl end group of typically between 1.66 and 6.66, and preferably between 2.22 and 4.0. The degree of polymerisation (Dp) or number of repeat units that exist in the oligomeric PET substrate may be between 1 and 10, more typically between 3 and 7, and preferably 6. In addition to being characterised by the degree of polymerisation (Dp) and the ratio of hydroxyl end group: carboxyl end group, the oligomeric PET substrate is also characterised by its carboxyl acid end group concentration, referred to herein as CEG. The CEG (units are mols acid ends/te of material) is typically between 300 and 1500, and preferably between 500 and 1200 or even between 700 and 1100.

In one non-limiting embodiment, the oligomeric PET substrate comprises a hydroxyl end group: carboxyl end group ratio of between 1.66 and 6.66, a Dp of between 4 and 7 and a CEG of between 700-1100 mols acid ends/te of material.

The source of the benefit associated to the optimised end group ratio is found in the balance of the reaction rates for esterification over polycondensation, the relative partial pressures of the condensation products, i.e., of water and ethylene glycol, and the balance of the chemical equilibrium constants of esterification as compared with polycondensation. This balance results in a natural optimum in the range 2.22 to 4.0 as specified earlier.

In one non-limiting embodiment, the rBHET is in a powder form and is melted prior to addition to the reaction zone. This rBHET in a molten form is added to the process containing under-esterified PTA oligomer in the reaction zone which precedes the injection of additives into said process.

In one non-limiting embodiment, the under-esterified PTA oligomer is in the range of 5 wt % to 50 wt %, and preferably in the range of 20 wt % to 40 wt %.

In one non-limiting embodiment, the rBHET is reacted with under-esterified PTA oligomer at a temperature between 120° C. and 300° C., and preferably between 150° C. and 270° C.

In one non-limiting embodiment, the residence time in the reaction zone may be between 30 minutes to 120 minutes, and preferably between 40 to 50 minutes.

In one non-limiting embodiment, the rBHET is reacted with under-esterified PTA oligomer at a pressure from 3 barg to 20 barg.

In an alternative embodiment, an alternative approach to under-esterification is used in which approximately 50 wt % rBHET, along the usual PTA/EG slurry, is fed into a smaller esterifier thereby reducing the residence time and limiting the extent of PTA esterification reaction.

In one non-limiting embodiment, the rBHET is fed into the esterifier at a ratio in the range of 40 wt %-55 wt %, and preferably in the range 45 wt % to 51 wt %.

In one non-limiting embodiment, the rBHET is reacted with an under-esterified PTA oligomer at a temperature in a range of 180° C. to 300° C., and preferably in the range between 240° C. to 300° C.

In one non-limiting embodiment, the rBHET is reacted with the under-esterified PTA oligomer in the esterifier with a residence time of 60 minutes to 100 mins, and preferably 85 minutes to 95 minutes.

In one non-limiting embodiment, the rBHET is reacted with under-esterified PTA oligomer in the esterfier at a pressure from 0.05 barg to 2 barg.

The reaction may be catalysed or uncatalyzed, depending on the composition of the PCR flake that was used to make the rBHET. In one non-limiting embodiment, the rBHET and under-esterified PTA oligomer are reacted with an exogenously added catalyst. A post-consumer PET-containing waste material or PCR flake may include a latent catalyst as a result of its manufacturing process. Therefore, in some embodiments the rBHET derived from PCR flake may have sufficient endogenous catalyst. Nevertheless, additional exogenous catalyst may still be added where desirable. Non-limiting examples of catalysts that may be added to the reaction include catalysts including antimony, titanium, zinc, manganese, germanium, aluminium and tin. These may be selected from an antimony-containing catalyst, a titanium-containing catalyst, a zinc-containing catalyst, an acetate-containing catalyst, a manganese-containing catalyst, a germanium-containing catalyst, an aluminium-containing catalyst or a tin-containing catalyst. These may be, for example, antimony trioxide, antimony glycolate, antimony triacetate, titanium alkoxide, zinc acetate or manganese acetate. Such catalysts are added to the reaction zone typically known as the esterification unit. A titanium-containing catalyst is typically added at 2-100 ppm, and preferably around 10 ppm, with regard to final PET polymer. All other catalysts (except a titanium-containing catalyst is typically added at 40-300 ppm, preferably around 240 ppm.

In some non-limiting embodiments, the oligomeric PET substrate is used in a rPET manufacturing process, one that had previously been designed to synthesise vPET but which has been retrofitted to make rPET. In an alternative non-limiting embodiment, the oligomeric PET substrate is used in a rPET manufacturing process that was specifically designed from the outset to make rPET.

An aspect of the present disclosure also relates to an oligomeric PET substrate produced by or obtainable by a method as described herein. In one non-limiting embodiment, the present disclosure relates to oligomeric PET substrate produced by using rBHET derived from PCR flake.

In some embodiments, the oligomeric PET substrate has a structure according to Formula I:

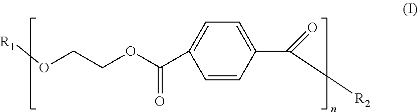

wherein R1 is a carboxyl end group or a hydroxyl end group, R2 is a carboxyl end group or a hydroxyl end group, and n is a degree of polymerisation, and wherein the oligomeric PET substrate is represented by two or more of the following characteristics:

i) n is a degree of polymerisation of 1 to 10;
ii) a CEG (mols acid ends/te of material) of from 300 to 1500; and
iii) a hydroxyl end group/carboxyl end group ratio in the range of 1.66 to 6.66.

In some embodiments, the oligomeric PET substrate is represented by the following characteristics: (i) n is a degree of polymerisation of 1 to 10 and (ii) a CEG (mols acid ends/te of material) of from 300 to 1500. In some embodiments, the oligomeric PET substrate is represented by the following characteristics: (i) n is a degree of polymerisation of 3 to 7 and (ii) a CEG (mols acid ends/te of material) of from 700 to 1100.

A further aspect of the present disclosure relates to PET polymer manufactured in a polymerisation process using oligomeric PET substrate produced by or obtainable by a method as described herein. The PET polymer may be in a range of 5-100% rPET. Therefore, the PET polymer may include a mixture of vPET and rPET.

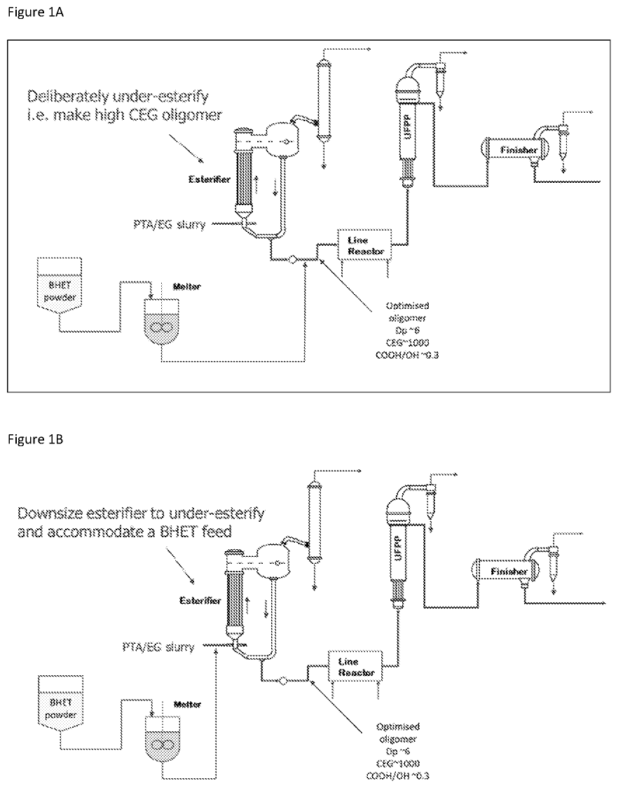

Referring to FIG. 1A, a system 100 according to one aspect of the present disclosure is shown for the production of an oligomeric PET substrate from a rBHET powder stored in a hopper 110. In the system 100 shown, the rBHET powder is fed from the hopper 110 to a melting vessel 120, where the rBHET powder is melted and stirred. The molten rBHET is then mixed with an under-esterified PTA oligomer. Under-esterification is achieved from an existing esterifier by running at lower T, lower EG:TA mole ratio, lower inventory, etc. The mixture is supplied to a reaction zone 130, also known as line reactor 130. Line Reactor 130 provides residence time at temperature to complete the reaction of the rBHET with the under-esterified oligomer. In terms of the examples, it refers to the oligomer hold period. The reaction zone 130 is maintained under conditions such that the rBHET catalytically reacts with the under-esterified PTA oligomer to produce an oligomeric PET substrate. The effluent from the reaction zone 130 is then fed firstly to a pre-polymeriser vessel 150 and then to a finisher vessel 160 to increase a degree of polymerisation of the monomer.

Referring to FIG. 1B, an alternative system 100a according to one aspect of the present disclosure is shown for the production of an oligomeric PET substrate from a rBHET powder stored in a hopper 110. In the system 100a shown, the rBHET powder is fed from the hopper 110 to a melting vessel 120, where the rBHET powder is melted and stirred. In contrast to FIG. 1A, the molten rBHET is mixed along with ethylene glycol and PTA in a downsized esterifier 140, thereby reducing a residence time and limiting an extent of a PTA esterification reaction.

### EXAMPLES

[Aspects of the disclosure are demonstrated by process modelling examples of continuous polymerisation (CP) operation which illustrate the predicted impact of the addition of BHET to an under-esterified PTA-based oligomer.

### Example 1

The following and subsequent examples take the form of a process model simulations of a three vessel CP process operating at 450 tonnes per day making a typical bottle resin grade PET. The reactor train includes an Esterifier, UFPP and Finisher vessel. The process conditions used for the simulation are described below:

| Parameter | Value | Units |
|---|---|---|
| Esterifier | | |
| Feed mole ratio | 1.89 | moles EG:moles TA |
| Temperature | 270 | ° C. |
| Pressure | 0.1 | barg |
| Residence time | 199 | mins |
| Additives zone | | |
| Sb | 280 | ppm |
| P | 20 | ppm |
| Co | 40 | ppm |
| EG | 200 | kg/hr |
| Oligomer COOH | 815 | microeq/g |
| Oligomer OH/COOH | 3.63 | |
| UFPP | | |
| Temperature | 294 | ° C. |
| Pressure | 20 | mmHg |
| Residence time | 27.9 | mins |
| Finisher | | |
| Temperature | 293 | ° C. |
| Pressure | 2.29 | mmHg |
| Residence time | 49.5 | mins |
| iV | 0.56 | dl/g |
| COOH | 43.0 | microeq/g |
| L | 67.3 | CIE |
| B | −0.61 | CIE |

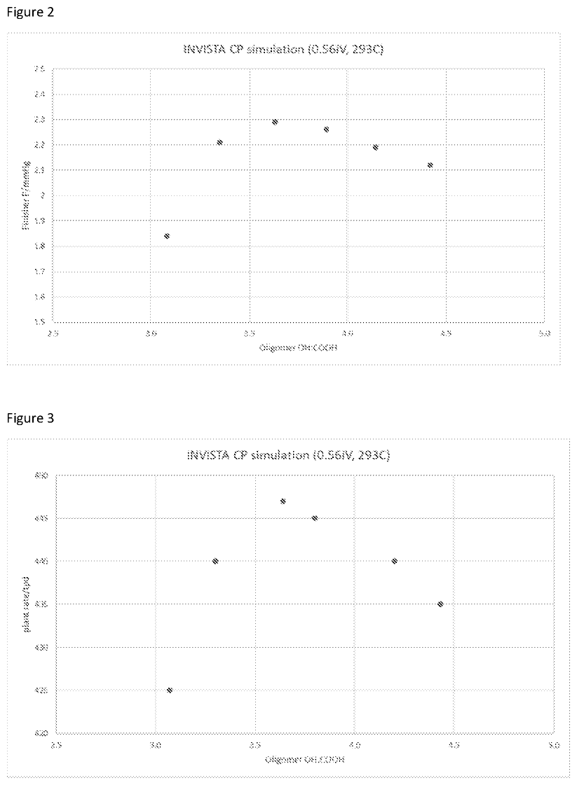

As shown in the above table, the key parameters of interest are the oligomer OH:COOH value of 3.63 and the 2.29 mmHg finisher pressure. By increasing the Esterifier feed mole ratio, the effect is to alter the oligomer OH:COOH upwards and impact the reactivity, hence thereby predicting the Finisher vacuum requirement. The predicted effect is shown in FIG. 2.

An alternative way to represent this is to simulate the plant rate, or plant capacity as function of oligomer OH:COOH whilst maintaining a constant Finisher vacuum. This is shown in FIG. 3, from which it will be seen that a change in oligomer OH:COOH from about 3.1 to about 3.6 is equivalent to about 5% increase in plant capacity.

### Example 2

The following is an example of the three vessel CP process as in Example 1, operating at 450 tonnes per day making the same typical bottle resin grade PET, but this time with a BHET feed.

| Parameter | Value | Units |
|---|---|---|
| Additives zone | | |
| BHET | 24800 | kg/hr |
| Sb | 280 | ppm |
| P | 20 | ppm |
| Co | 40 | ppm |
| EG | 0 | kg/hr |
| Oligomer COOH | 17 | microeq/g |
| Oligomer OH/COOH | 508 | |
| UFPP | | |
| Temperature | 294 | ° C. |
| Pressure | 20 | mmHg |
| Residence time | 27.9 | mins |
| Finisher | | |
| Temperature | 293 | ° C. |
| Pressure | 1.58 | mmHg |
| Residence time | 49.5 | mins |
| iV | 0.56 | dl/g |
| COOH | 14.0 | microeq/g |
| L | 59.2 | CIE |
| B | −1.76 | CIE |

As shown in the above table, the key parameters of interest are the very high 508 oligomer OH:COOH and the much reduced 1.58 mmHg finisher pressure requirement. This oligomer OH:COOH is so large that, to raise the Finisher pressure to 2.3 mmHg, as in example 1, the plant rate would drop to 390 tpd, representing a capacity reduction of some 20%. The deterioration in L* color is also significant.

### Example 3

In this example, the process parameters of Example 2 are held constant but now add a 50% BHET feed and vary the esterification conditions to deliberately under-esterify the feed. As a consequence, the esterifier product COOH rise and its Dp falls, thereby producing an oligomer of varying OH:COOH ratio. As this reacts with the BHET, the following set of results is predicted:

| Esterifier | Esterifier | Oligomer | Oligomer | Finisher | Finisher P/ |
|---|---|---|---|---|---|
| COOH | Dp | COOH | OH:COOH | COOH | mmHg |
| 1240 | 5.99 | 333 | 17.3 | 14.3 | 1.57 |
| 1310 | 5.81 | 349 | 16.5 | 14.4 | 1.58 |
| 2220 | 5.38 | 557 | 10.1 | 18.1 | 1.78 |
| 2730 | 5.08 | 667 | 8.41 | 23.4 | 2.0 |
| 3580 | 4.89 | 853 | 6.4 | 42 | 2.37 |
| 4220 | 4.61 | 998 | 5.4 | 70.7 | 1.61 |

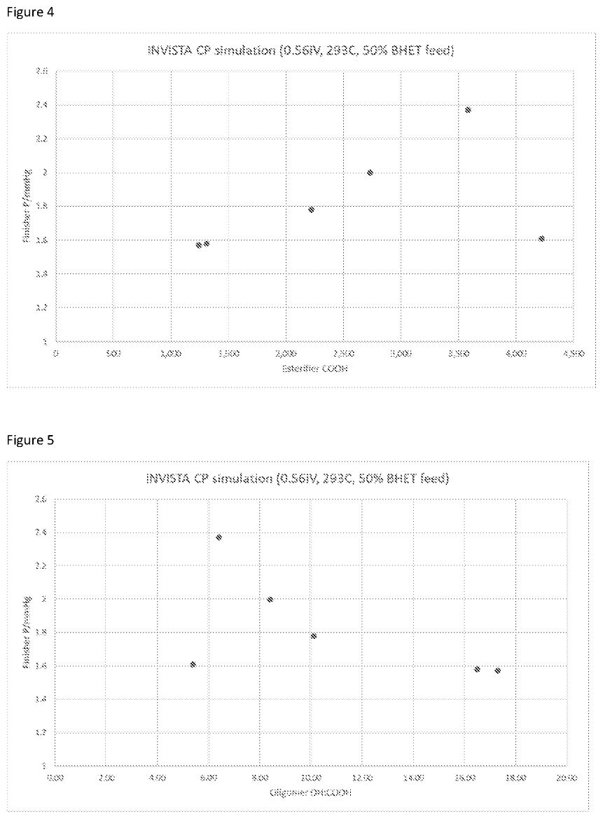

As shown in FIG. 4, a clear optimum is seen at around 3500 Esterfier COOH, as represented by a maximum in the predicted Finisher vacuum requirement. Further, FIG. 5 shows a Finisher vacuum requirement against the resulting oligomer OH:COOH. As shown in FIG. 5, an optimum Esterifier OH:COOH of around 7:1 occurs for a 50% BHET feed. Clearly, based on the improvement in Finisher vacuum requirement, the operation of the plant can be restored to the full 450 tpd with this optimised Esterifier under-esterified product.

The table below shows a set of predictions which occur with a 30% BHET feed:

| Esterifier | Esterifier | Oligomer | Oligomer | Finisher | Finisher P/ |
|---|---|---|---|---|---|
| COOH | Dp | COOH | OH:COOH | COOH | mmHg |
| 1230 | 5.99 | 519 | 8.63 | 16.1 | 1.66 |
| 1280 | 5.74 | 535 | 8.45 | 16.5 | 1.68 |
| 1740 | 5.39 | 707 | 6.35 | 24.6 | 2.02 |
| 2330 | 5.19 | 933 | 4.69 | 55.1 | 2.19 |
| 2490 | 5.19 | 996 | 4.35 | 70.1 | 1.60 |

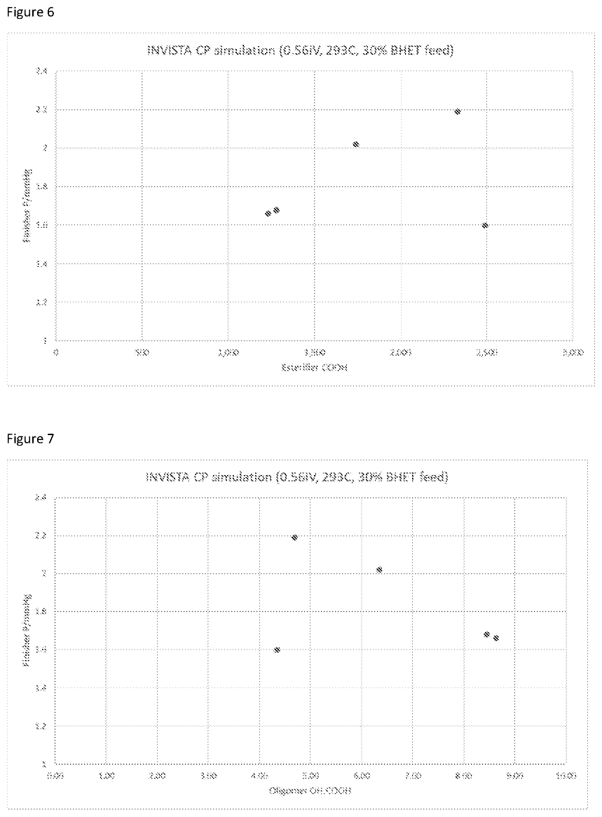

FIG. 6 shows a Finisher pressure required against the Esterifier COOH. As shown in FIG. 6, a clear optimum is seen at around 2200 for Esterifier COOH, as represented by a maximum for the predicted Finisher vacuum requirement.

FIG. 7 shows a Finisher vacuum requirement against the Esterifier product. As shown in FIG. 7, an optimum Esterifier OH:COOH occurs around 5:1 for a 30% BHET feed. Clearly, based on the improvement in Finisher vacuum requirement, the operation of the plant can be restored to the full 450 tpd with this optimised Esterifier under-esterified product.

An alternative approach to under-esterification would be feed say 50 wt % rBHET, along the usual PTA/EG slurry, into a smaller esterifier thereby reducing the residence time and limiting the extent of PTA esterification reaction. The following simulation is of the three vessel CP process of example 1, again operating at 450 tonnes per day for a resin grade PET but with 50 wt % BHET feed and utilising a much smaller esterifier. As shown in the table below, the esterifier residence time in the table below is now about 90 mins versus 200 mins in example 1. In order to further slowdown the PTA esterification rate, the temperature is lowered and the feed mole ratio is reduced. The process conditions used for the simulation are described in the table below:

| Parameter | Value | Units |
|---|---|---|
| Esterifier | | |
| Feed mole ratio | 1.61 | moles EG:moles TA |
| Slurry ratio | 52 | wt % |
| BHET ratio | 48 | wt % |
| Temperature | 260 | C. |
| Pressure | 0.1 | barg |
| Residence time | 92 | mins |
| Additives zone | | |
| Sb | 280 | ppm |
| P | 20 | ppm |
| Co | 40 | ppm |
| EG | 200 | kg/hr |
| Oligomer COOH | 868 | microeq/g |
| Oligomer OH/COOH | 4.05 | |
| UFPP | | |
| Temperature | 294 | C. |
| Pressure | 20 | mmHg |
| Residence time | 27.9 | mins |
| Finisher | | |
| Temperature | 293 | C. |
| Pressure | 2.3 | mmHg |
| Residence time | 49.5 | mins |
| iV | 0.56 | dl/g |
| COOH | 44.6 | microeq/g |
| L | 67.2 | CIE |
| B | −1.39 | CIE |

In embodiments, for these conditions, the oligomer OH:COOH value is seen to be 4.05 resulting in the desirable Finisher vacuum requirement of 2.3 mmHg. The table below shows that if the esterifier volume and hence residence time is adjusted, the following set of predictions can be generated.

| Esterifier | Oligomer | Oligomer | Finisher | Finisher P/ |
|---|---|---|---|---|
| rtime/mins | COOH | OH:COOH | COOH | mmHg |
| 68.3 | 964 | 3.66 | 64.7 | 1.83 |
| 80.1 | 920 | 3.81 | 54.6 | 2.17 |
| 92 | 868 | 4.05 | 44.6 | 2.3 |
| 103.7 | 834 | 4.18 | 39.3 | 2.29 |
| 115 | 793 | 4.45 | 33.6 | 2.23 |
| 140 | 737 | 4.75 | 27.7 | 2.1 |

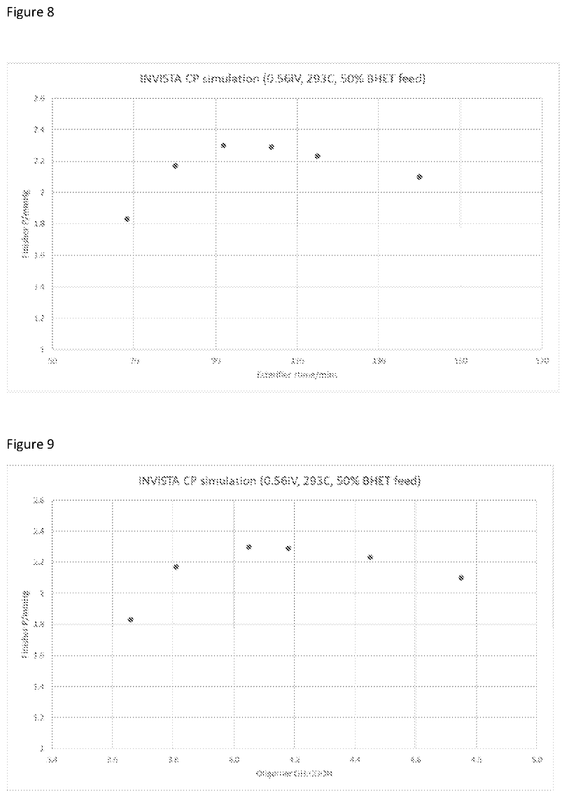

FIG. 8 shows an optimum esterifier residence time of about 95 mins to minimise the Finisher vacuum requirement.

Alternatively, FIG. 9 shows that with the same data, an optimum oligomer OH:COOH value of about 4.1 minimizes the Finisher vacuum requirement.

1. A method for producing an oligomeric polyethylene terephthalate (PET) substrate for use in a recycled PET (rPET) manufacturing process, comprising:
i) adding recycled bis-hydroxylethyleneterephthalate (rBHET) and an under-esterified PTA oligomer in a reaction zone; and
ii) reacting the rBHET and the under-esterified PTA in the reaction zone to produce an oligomeric PET substrate represented by Formula I: 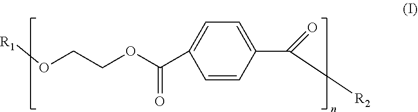
wherein R1 is a carboxyl end group or a hydroxyl end group, R2 is a carboxyl end group or a hydroxyl end group, and n is a degree of polymerisation (Dp).

2. The method according to claim 1, wherein n is from 1 to 10, preferably 3 to 7, and more preferably n is 6.

3. The method according to claim 1, wherein the oligomeric PET substrate has a CEG of between 300 to 1500 mols acid ends/te of material, preferably from 500 to 1200 mols acid ends/te of material, and more preferably from 700 to 1100 mols acid ends/te of material.

4. The method according to claim 1, wherein the oligomeric PET substrate has a hydroxyl end group: carboxyl end group ratio in the range of 1.66 to 6.66, preferably in a range of 2.22 to 4.0.

5. The method according to claim 1, wherein the under-esterified PTA oligomer is in the range 5 wt % and 50 wt %, preferably in a range of 20 wt % to 40 wt %.

6. The method according to claim 1, wherein the rBHET is reacted with the under-esterified PTA oligomer at a temperature between 120° C. to 300° C., preferably from 150° C. to 270° C.

7. The method according to claim 1, wherein the reaction zone comprises a residence time of between 30 minutes to 120 minutes, preferably from 40 minutes to 50 minutes.

8. The method according to claim 1, wherein the rBHET is reacted with the under-esterified PTA oligomer at a pressure between 3 barg to 20 barg.

9. The method according to claim 1, wherein the rBHET is fed into an esterifier in addition to PTA and ethylene glycol.

10. The method according to claim 9, wherein the rBHET is fed into the esterifier at a ratio in a range of 40 wt %-55 wt %, preferably in a range of 45 wt % to 51 wt %.

11. The method according to claim 1, wherein the rBHET is reacted with the under-esterified PTA oligomer using an exogenously added catalyst selected from an antimony-containing catalyst, titanium-containing catalyst, a zinc-containing catalyst, an acetate-containing catalyst, a manganese-containing catalyst, a germanium-containing catalyst, an aluminium-containing catalyst, a tin-containing catalyst and combinations thereof.

12. The method according to claim 11, wherein the catalyst comprises at least one of antimony trioxide, antimony glycolate, antimony triacetate, titanium alkoxide, zinc acetate or manganese acetate.

13. The method according to claim 1, wherein the oligomeric PET substrate is fed directly or indirectly into the rPET manufacturing process.

14. An oligomeric PET substrate, wherein the oligomeric PET substrate is represented by Formula I 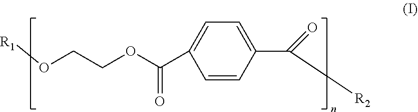
and comprises at least two of the following characteristics:
i) n is a degree of polymerisation of 1-10;
ii) a CEG (mols acid ends/te of material) of between 300 and 1500; or
iii) a hydroxyl end group/carboxyl end group ratio in the range of 1.66 to 6.66,
and wherein the oligomeric PET substrate is used in synthesis of a polymer comprising 5-100% rPET.

15. A PET polymer made from 5-100% rPET, produced by the oligomeric PET substrate as claimed in claim 14.
